(19) United States
(12) Patent Application Publication
(10) Pub. No.: US 2012/0330962 A1
(43) Pub. Date: Dec. 27, 2012

(54) Method and Apparatus of Providing Suggested Terms

(75) Inventors: Peng Huang, Hangzhou (CN); Feng Lin, Hangzhou (CN); Shousong Zhang, Hangzhou (CN); Wei Zheng, Hangzhou (CN); Jiong Feng, Hangzhou (CN); Qin Zhang, Hangzhou (CN)

(73) Assignee: ALIBABA GROUP HOLDING LIMITED, Grand Cayman (KY)

(21) Appl. No.: 13/522,142

(22) PCT Filed: May 24, 2012
(86) PCT No.: PCT/US12/39426

§ 371 Date: Jul. 13, 2012

(30) Foreign Application Priority Data
May 26, 2011 (CN) 201110138955.X

(51) Int. Cl. G06F 17/30

(52) U.S. Cl. 707/740; 707/E17.046; 707/E17.066

(57) ABSTRACT

The present disclosure discloses a method of providing suggested terms. The method includes: receiving an initial query input from a user, and obtaining corresponding suggested queries based on the initial query; determining at least two categories corresponding to the suggested queries and at least two clickable regions usable for looking up the suggested queries; separately determining a category weight associated with each obtained category in each clickable region for the suggested queries, and a click attribute weight associated with each clickable region; computing a degree of confidence of each category for the suggested queries; and separately determining target categories for the suggested queries based on the degree of confidence of each category for the suggested queries. As such, the user may quickly identify his/her search intention based on the target categories corresponding to the suggested queries, thereby effectively improving the speed of information searching.

### CROSS REFERENCE TO RELATED PATENT APPLICATIONS

This application is a national stage application of an international patent application PCT/US12/39426, filed May 24, 2012, which claims priority to Chinese Patent Application No. 201110138955.X, filed on May 26, 2011, entitled “Method and Device for Providing Suggested Terms”, which applications are hereby incorporated by reference in their entirety.

### TECHNICAL FIELD

The present disclosure relates to search technology, and in particular, to methods and apparatuses of providing suggested terms.

### BACKGROUND

With the rapid development of the Internet, electronic commerce has been widely integrated into the daily lives of people. In applications involving electronic commerce, searching by inputting search keywords is not only the main method and means for users to find and locate products that are of interest to them, but also a basic function that is most frequently used by the users. In order to quickly find and locate a desired product, a user needs to select an appropriate search keyword to describe his/her search objective.

Generally, users are accustomed to performing searches starting from abstraction to specificity. For instance, the user first inputs relatively general search keywords, then gradually narrows down the search scope by using more specific search keywords, and ultimately locates specific products.

In some cases, specialty products tend to have complicated and obscure spellings. Users may only manage to remember the beginning parts of search keywords, but forget the remaining parts thereof, thus requiring the users to locate respective desired products through multiple queries. Furthermore, inputting search keywords repetitively or repeatedly is a tedious process that not only reduces search efficiency but is also prone to input errors.

As shown in FIG. 1, in order to effectively improve search efficiency for the users, existing e-commerce websites generally perform automatic completion of search keywords submitted by the users, i.e., providing a series of suggested terms. In FIG. 1, a search user interface 100 has a search field 102 into which the user has begun to enter a search keyword, such as “Apple”. As the user enters the keyword, a list of suggestions 104 is provided. This method of efficiently providing suggested terms saves input time for a user, and relieves the user from the burden of constructing a complete search keyword. At the same time, high quality suggested terms can help the user to find and locate products that are of interest to him/her in a better way.

As the number of products of various types in e-commerce websites continues to grow, it is increasingly more time consuming to use conventional search processes involving entry of keywords when trying to find a desired product. Accordingly, there is a need for improved techniques for providing suggested terms, which builds upon existing technologies, to increase search efficiency associated with an e-commerce site and enhance service performance of the associated e-commerce system.

### SUMMARY

The embodiments of the present disclosure provide techniques for providing suggested terms in keyword search processes in a way that improves search efficiency while overcoming problems associated with conceptual vagueness of suggested terms in existing technologies.

In one aspect of the present disclosure, a method of providing suggested terms is disclosed. The method may include receiving an initial query input from a user, and obtaining a suggested query corresponding thereto based on the initial query. The method may determine at least two categories corresponding to the suggested query, and at least two clickable regions usable for querying the suggested query. In one embodiment, the method may separately determine a category weight associated with each determined category in each clickable region for the suggested query, and a click attribute weight associated with each clickable region. The method may further separately compute a degree of confidence of each category for the suggested query based on the category weight associated with each category, and the click attribute weight associated with each clickable region. The method may determine target categories of the suggested query based on the degree of confidence of each category for the suggested query. The method may then display the suggested query and the target categories.

In another aspect of the present disclosure, an apparatus of providing a suggested term is provided. The apparatus may include an acquisition unit to receive an initial query input from a user, and obtain a suggested query corresponding thereto based on the initial query. Furthermore, the apparatus may include a first determination unit to determine at least two categories corresponding to the suggested query, and at least two clickable regions usable for querying the suggested query. In one embodiment, the apparatus may further include a second determination unit. The second determination unit separately determines a category weight associated with each determined category in each clickable region for the suggested query, and a click attribute weight associated with each clickable region. Furthermore, the apparatus may include a computation unit to separately compute a degree of confidence of each category for the suggested query based on the category weight associated with each category, and the click attribute weight associated with each clickable region. A display unit may further be included and used for determining target categories of the suggested query based on the degree of confidence of each category for the suggested queries, and displaying the suggested query and the target categories.

In certain embodiments of the present disclosure, a dictionary of suggestions is established based on user query logs and category suggestions are based on a user click log. Therefore, in response to obtaining suggested queries based on an initial query (a query keyword) that is input from a user, a system may determine a target category for each suggested query based on the user's existing click behavior, and display the suggested queries and corresponding target categories at the same time. Accordingly, a guiding intention of each suggested query is displayed to the user based on the target categories, allowing the user to quickly determine his/her search intention based on the target categories of the suggested queries. This avoids interference from unrelated suggested queries, and thereby effectively improves the speed of information searching. Furthermore, the system takes advantage of performing a search under a target category corresponding to a suggested query selected by the user as opposed to performing searches under all categories. The amount of information to be searched is therefore greatly reduced, thus further improving the speed of information searching while reducing the processing workload of an associated server. The present disclosure may be applied in electronic products such as computers, wireless communications devices, etc.

### BRIEF DESCRIPTION OF THE DRAWINGS

The embodiments of the present disclosure will be described hereinafter in conjunction with the attached figures.

FIG. 1 is a schematic diagram showing provision of suggested terms in existing technologies.

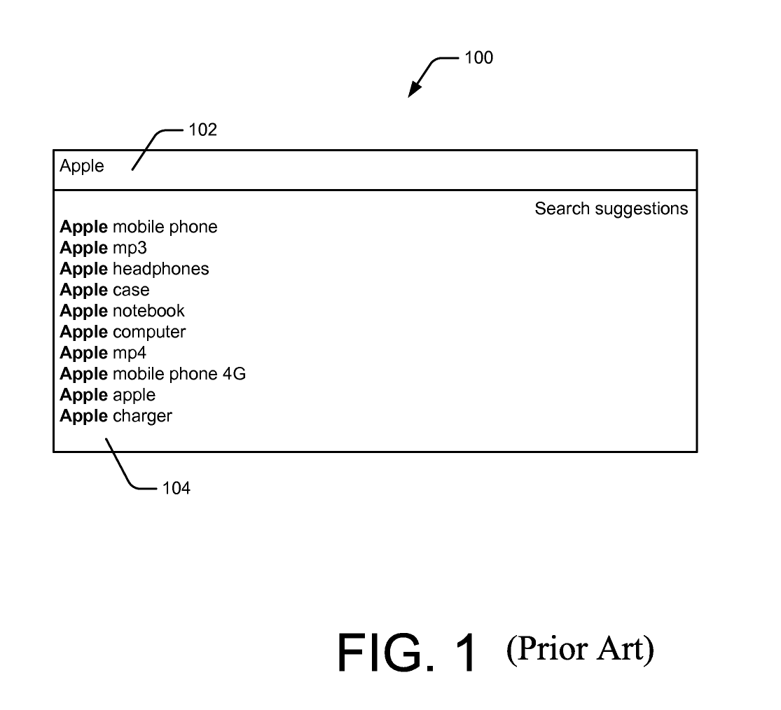

FIG. 2 is a schematic diagram showing principles of an apparatus of providing suggested terms in accordance with the embodiments of the present disclosure.

FIG. 3 is a schematic diagram showing a first weight setting in accordance with the embodiments of the present disclosure.

FIG. 4 is a schematic diagram showing a second weight setting in accordance with the embodiments of the present disclosure.

FIG. 5 is a flowchart showing provision of suggested terms in accordance with the embodiments of the present disclosure.

FIG. 6 is a block diagram showing functional components of a search apparatus in accordance with the embodiments of the present disclosure.

FIG. 7 is an exemplary apparatus described in FIG. 2 and FIG. 6 in more detail.

### DETAILED DESCRIPTION

Dictionaries play an important role in completing query inputs. All suggested terms are generated using the dictionaries. For example, if a user enters “pho”, suggested terms prefixed with “pho”, such as “phone”, “photo”, “photo frame”, “photo album”, etc., may be obtained by looking up a dictionary.

One process that may be used to construct a dictionary is given as follows:

1. Input a query log of a user;

2. Pre-process the query log of the user, which includes elimination of illegible characters, standardization of punctuation writing, correction of spelling mistakes (a user may enter a wrong search keyword due to a typing error), and conversion of plurals into singular forms, etc. Upon pre-processing, these search keywords form a candidate term set;

3. Select a candidate term from the candidate term set generated in step 2;

4. Extract and remove the leftmost letter from the candidate term. For example, extract the letter “p” from a candidate term “phone” so that the candidate term becomes “hone” after the first letter is removed;

5. Add the candidate term “phone” to a set of suggested terms that have the first letter “p”;

6. Repeat steps 4 and 5 until all the letters of the candidate term are extracted;

7. Add the candidate term “phone” to a suggested term set corresponding to “phone”;

8. Repeat steps 3-7 until the candidate term set is empty;

9. Complete construction of a suggested term dictionary.

The space available for displaying suggested terms on an e-commerce site is limited, and may only display a limited number of suggested terms. However, the number of suggested terms that match a search keyword input by a user is generally far greater than that limit. Therefore, a certain number of suggested terms having the highest “quality” are to be selected for display.

In the present embodiments, a precedence level is used to measure the quality of a suggested term—the higher the precedence level is, the better the quality will be. Specifically, an ordering is first performed using degrees of matching between suggested terms and a search keyword. If the first word of a suggested term matches the search keyword, a match position is “0”. If the second word is matched, then the match position is “1”, and so forth. The precedence level is higher if the match position is nearer to the beginning. For example, if “phone” is entered, the suggested term “phone case” is better than “mobile phone”, because the match position of the former one is 0, while the match position of the latter one is 1.

In the field of electronic commerce, each e-commerce product is classified into a particular category (or multiple categories). A category in the e-commerce field is a product classification corresponding to a product. For example, a category corresponding to mobile phones might be “communications equipment”, and a category corresponding to cameras might be “digital products”, and so forth. Query behavior of a user is usually related to a particular category. The embodiments of the present disclosure therefore relate the suggested terms with categories, and recommend them jointly to the user. As such, the user can select a category to filter away some interference factors. These interference factors correspond to suggested terms that are irrelevant to the search purpose of the user. The search efficiency of the system is therefore improved.

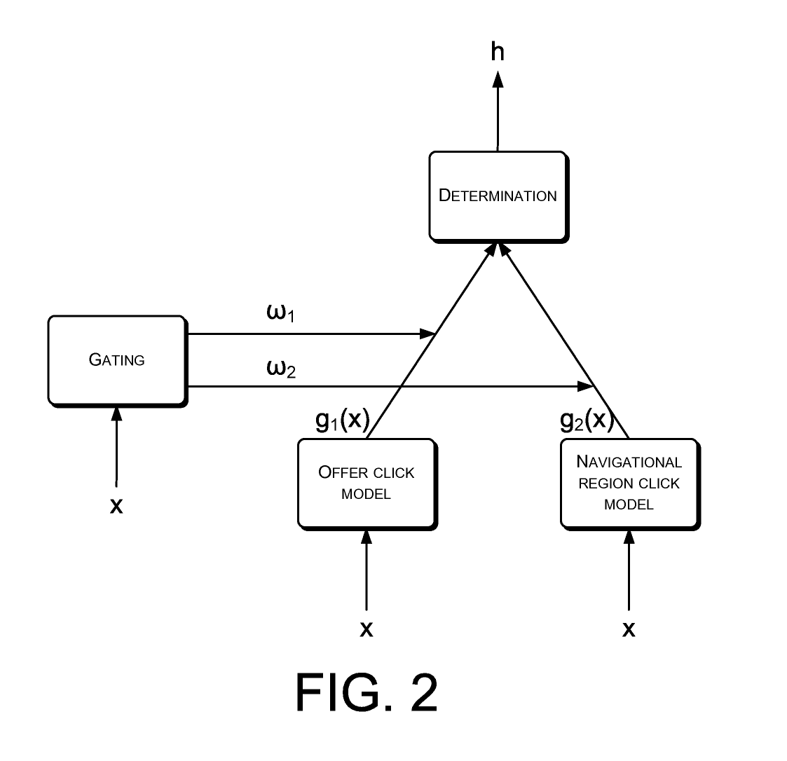

Under normal circumstances, upon entering a search keyword on an e-commerce website, a user may click and browse certain products in a non-navigational region of a web page, or click a category in a navigational region of the web page. Therefore, a relationship between the search keyword (i.e., a suggested term) and a category may be learned from a query log of the user. The techniques of the present disclosure define, as attributes, click behavior associated with an offer (i.e., click behavior associated with product information displayed in the non-navigational region of the web page) and click behavior associated with an e-commerce navigational region. The techniques employ linear models for fusion. The linear models include an offer click model and a navigational region click model respectively. A framework of the fusion is shown in FIG. 2.

First, two functions are respectively defined as follows.
click₁(offer, query)=cat', where “query” represents a certain search keyword entered by a user. “Offer” represents that the user has clicked on a web page associated with a certain product. cat' represents a category associated with the offer. The full function, click₁(offer, query)=cat', indicates whether the user has clicked on the category cat' in the web page associated with the offer after he/she has entered the query. A value of one represents that a click was made while a value of zero represents that no click was made.
click₂ (query)=cat″, where “query” represents a certain search keyword entered by the user. This function indicates whether the user has clicked on a certain category within a navigational region. The function, click₂ (query)=cat″, indicates whether the user has clicked on the category cat″ within the navigational region after he/she has entered the query. A value of one represents that a click was made while a value of zero represents that no click was made.

Based on the functions defined above, a click attribute model for a web page associated with an offer may be represented in Equation (1):

$${f}_{offer , query , {cat}^{′}} ( x , y ) = \{ \begin{matrix}1 & if x = query \& {click}_{1} ( offer , query ) = {cat}^{′} \\ 0 & otherwise\end{matrix} \qquad ( 1 )$$

Equation (1) represents a characteristic function “f” for an attribute extracted for an offer. For an offer, given a query (a query term, represented by x in the function) and cat' (category), the function can take on one of two values: one or zero (which is the value of an attribute). y in the characteristic function is defined as the click₁ function. Given a query, the value of the function is one when click₁(offer,query)=cat' for that query, and is zero otherwise. Using this function, an offer is allowed to be converted into an attribute space. This attribute space indicates categories of product information that the user has clicked thereon in the web page associated with the Offer after he/she has entered a query (or multiple queries).

Based on the functions defined above, a navigational region click attribute model may be represented in Equation (2):

$${f}_{sn , {cat}^{″}} ( x , y ) = \{ \begin{matrix}1 & if x = query \& {click}_{2} ( query ) = {cat}^{″} \\ 0 & otherwise\end{matrix} \qquad ( 2 )$$

Equation (2) represents a characteristic function “f” for an attribute extracted for a navigational region. Given a query (a query term, represented by x in the function) and a category, the function takes on one of two values: one or zero (which correspond to a value scope of an attribute value). y in the characteristic function is defined as the click₂ function. Given a query, an attribute value for a category in a navigational region may be computed to be one if click₂ (query)=cat″, and is zero otherwise. Using this function, an attribute space may be generated based on a query and a category of a navigational region. This attribute space indicates which categories the user has clicked thereon within the navigational region after he/she has entered a query (or multiple queries).

Click data associated with the offer and click data associated with the navigational region may be used as training data. Through this training, category weights of each category under click attributes of the offer and click attributes of the navigational region may be obtained. Alternatively, these may also be referred to as category weights of each category under clickable regions of the offer and clickable regions of the navigational region. Alternatively, these may be interpreted as, for a specific query, probabilities that a user clicks on each category within the clickable regions of the offer, and probabilities that the user clicks on each category within the clickable regions of the navigational region. Specifically, weights may be defined as:

1) As shown in Equation (3), category weights in a clickable region of an offer are:

$${g}_{1} ( x , y ) = p ( y = {cat}^{′} \vert x = query ) = \frac{offer\_cnt ( {cat}^{′} , query )}{{\sum }_{j} offer\_cnt ( {cat}_{j} , query )} \qquad ( 3 )$$

where “offer_cnt” represents, for a specific query, a total number of clicks associated with an offer with a category being cat' among the click data associated with the offer. The element “catⱼ” represents a certain predetermined category. In practical applications, a great number of products on an e-commerce site are classified into a particular category, for example, “fruits”. “j” is used to label different categories.

For example, if a given query is “apple”, and the user has clicked 75 offers under a category “fruits” and 25 offers under a category “electronics”, then g₁ (“apple”, “fruits”)=0.75, and g₁ (“apple”, “electronics”)=0.25;

2) As shown in Equation (4), category weights in a clickable region of a navigational region are:

$${g}_{2} ( x , y ) = p ( y = {cat}^{″} \vert x = query ) = \frac{sn\_cnt ( {cat}^{″} , query )}{{\sum }_{j} sn\_cnt ( {cat}_{j} , query )} \qquad ( 4 )$$

where “sn_cnt” represents, for a specific query, a total number of clicks associated with category cat″ among the click data associated with the navigational region. The label “j” is used to label different categories. If there exist category 1, category 2, category 3, . . . , category n, j=1, 2, . . . , n, which allow computation of a total number of clicks under all categories for a particular query.

For example, a given query is assumed to be “apple”, and two categories, category 1: “fruits” and category 2: “electronics”, are displayed in a navigational region. For the query “apple”, if the total number of clicks for category 1 in the navigational region is 75, and the total number of clicks for category 2 in the navigational region is 25, then g₂ (“apple”, “fruits”)=0.75, and g₂ (“apple”, “electronics”)=0.25.

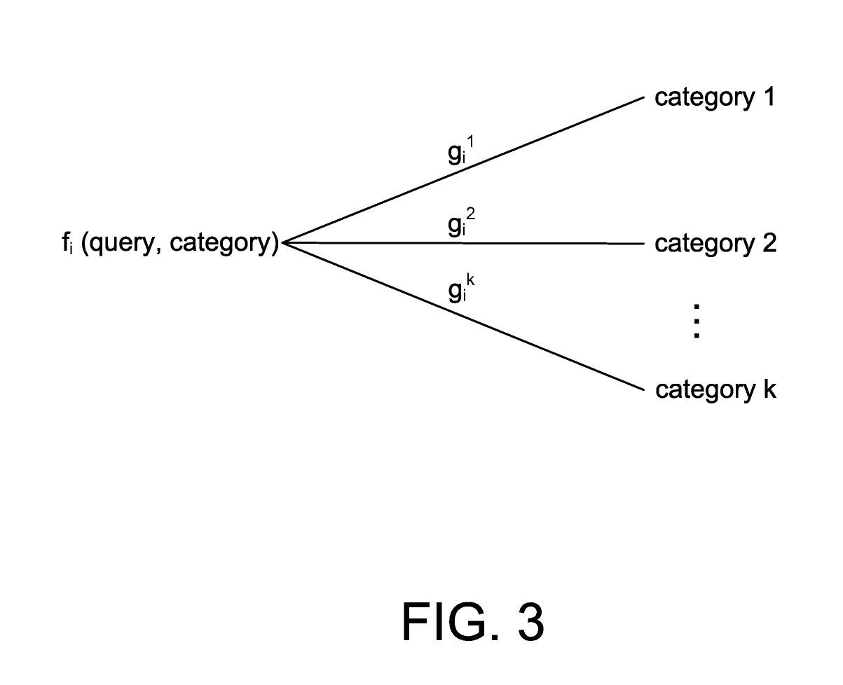

As shown in FIG. 3, in one embodiment, individual click attributes fᵢ may need to be multiplied with corresponding weights gᵢ. This allows better discrimination among different individual click attributes because gᵢ is a maximum likelihood classifier, which reflects a resulting empirical distribution in the training data. Specifically, fᵢ represents an extracted click attribute. By multiplying this click attribute with its corresponding gᵢ towards which category the query is more biased under this click attribute fᵢ may be observed. For example, in the above example, both g₁ and g₂ are biased towards the “fruits” category (both are 0.75). Therefore, the click attribute fᵢ is biased towards category 1—“fruits”.

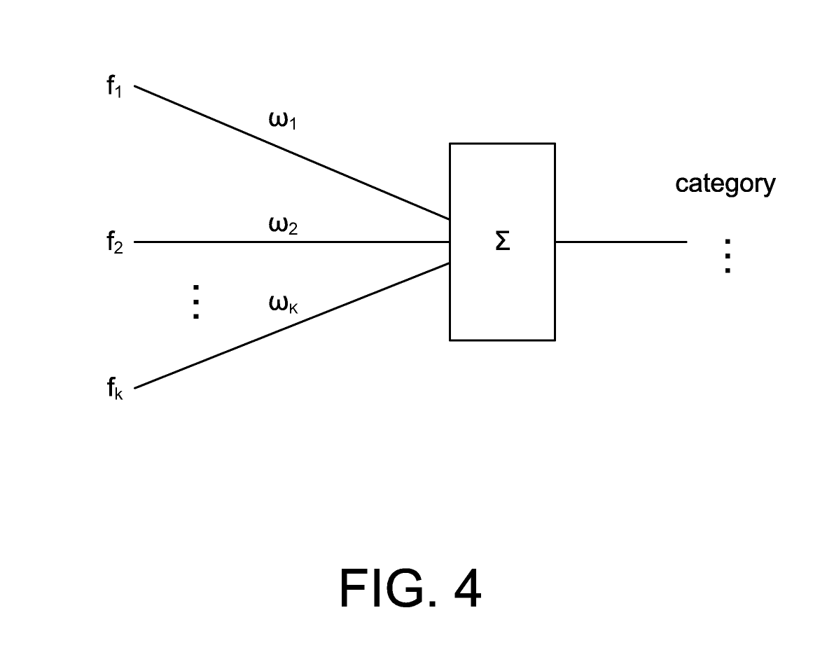

Based on the foregoing embodiments, a final operation of determination combines click attributes corresponding to all clickable regions. Specifically, click weights w are needed to discriminate between the click attributes corresponding to the clickable regions. Therefore, a gating process is introduced to evaluate a degree of importance of each attribute, i.e., computing w. Specifically, as shown in FIG. 4, w associated with each click attribute is predetermined by an administrator based on testing results.

As can be seen from the settings of the above functions, g represents a degree of importance of a particular click attribute with respect to an outputted category. The variable w represents relative degrees of importance between click attributes.

In practical applications, if the training data is tagged, w may be obtained using maximum likelihood estimation (MLE) training. Indeed, the parameter g may not be needed in this situation (but the parameter g may be used as a click attribute value, which is no longer has a value of zero or one), and parameters of the attributes can be trained directly. If the training data is not tagged, w can be set by using the degrees of confidence associated with the click attributes corresponding to the clickable regions (or referred to as degrees of confidence of the clickable regions). For example, in a clickable region of an offer, W₁ corresponding to a click attribute of the offer is set as: ω₁=1−pₑᵣᵣₒᵣ, where pₑᵣᵣₒᵣ represents an error rate when determination is performed based on the click attribute of the offer. The value of ω of the center NP can be set to be a similarity value between itself and an original query.

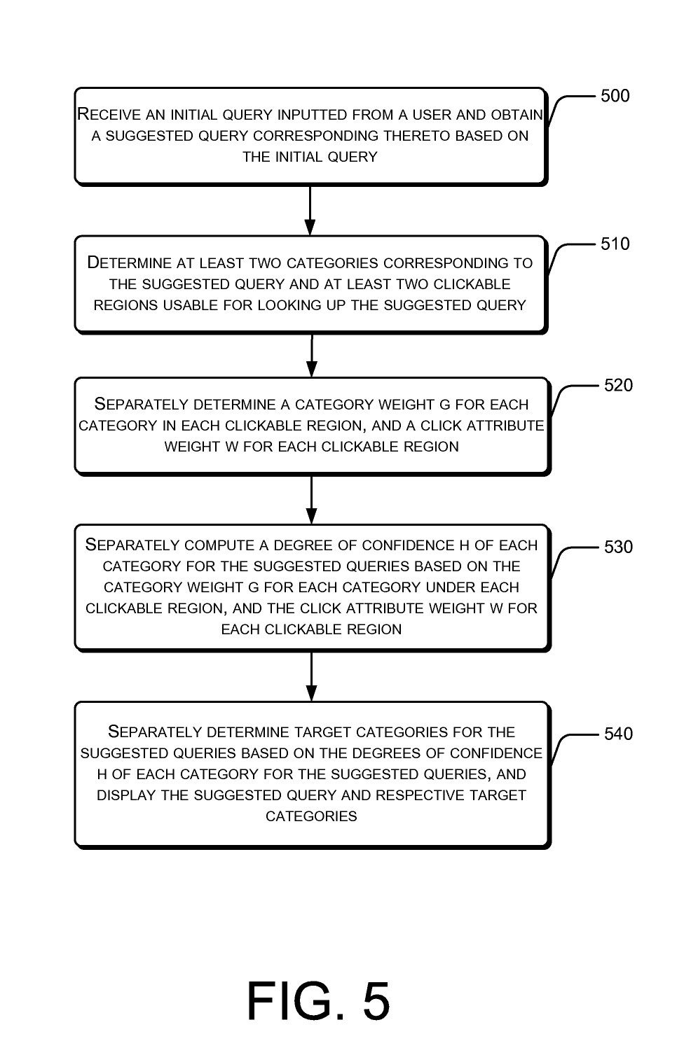

Based on the functions defined above, according to the embodiments of the present disclosure as shown in FIG. 5, a detailed process of providing suggested terms to a user by a search apparatus based on an initial query of the user is given as follows.

Block 500 receives an initial query input by a user, and obtains corresponding suggested queries based on the initial query. In this embodiment, due to incompleteness of the initial query, upon receiving the initial query input from the user, the search apparatus needs to complete the initial query using a predetermined dictionary in order to obtain corresponding suggested queries, i.e. obtaining corresponding suggested terms based on the initial query. For example, if the user inputs “pho”, the search apparatus may obtain suggested terms (i.e., suggested queries) prefixed with “pho”, such as, “phone”, “photo”, “photo frame”, “photo album”, etc., by looking up a dictionary. For another example, if the user enters “app”, the search apparatus may look up the dictionary to obtain a suggested query “apple”. Still another example, if the user enters “apple”, the search apparatus may obtain suggested queries “apple phone”, “apple MP3”, etc., by searching the dictionary. The following embodiments will assume the initial query entered by the user to be “app” and the suggested term to be “apple” that is obtained by the search apparatus after completing the initial query based on the dictionary as an example.

Block 510 separately determines at least two categories corresponding to the suggested queries, and at least two clickable regions usable for looking up the suggested queries. In this embodiment, assume that two categories correspond to “apple” are “fruits” and “electronics” respectively, and two clickable regions are usable for looking up the suggested query, with one being an offer web page, and the other being a navigational region.

Block 520 determines a category weight g for each category in each clickable region and a click attribute weight w for each clickable region. In this embodiment, when determining a category weight g for any category (referred to as category x) in any clickable region (referred to as region x), it is computed using the following approach: determining a corresponding category weight g, i.e., a category weight for the category x within the region x, based on a ratio between a total number of clicks corresponding to the category x within the region x for the suggested query and a total number of clicks corresponding to all categories within the region x for the suggested query. Specific details of the computation can be referenced to Equation (3) and Equation (4), and are not redundantly repeated herein.

Further, a method of determining a click attribute weight w for any clickable region is given as follows. If the training data is tagged, w is obtained using maximum likelihood estimation. If the training data is not tagged, w is set using a corresponding degree of confidence of any clickable region of the above. The specific setting methods have been described in the foregoing embodiments, and are not redundantly repeated herein.

The values of the aforementioned parameters g and w may be determined and stored by the administrator in advance, and may be updated in real time based on a change in user data, or computed in real time based on current user data in response to obtaining a suggested query.

For example, for the suggested query “apple”, the system obtains statistics about user click behavior, finding that the number of user clicks under the category “fruits” within the region of the web page associated with the offer is seventy-five times, and the number of user clicks under the category “electronics” within the region of the web page associated with the offer is twenty-five times. In this case, g₁ (“apple”, “fruits”)=0.75, and g₁ (“apple”, “electronics”)=0.25. In the navigational region, the number of user clicks is eighty times under the category “fruits”, and is twenty times under category “electronics”. As such, g₂ (“apple”, “fruits”)=0.8, and g₂ (“apple”, “electronics”)=0.2.

Further, if the accuracy of predicting categories of a query using the offer click model is 80%, the click attribute weight w₁ for the web page associated with the offer is set to be 0.8. If the accuracy of predicting categories of a query using the navigational region click model is 60%, then the click attribute weight w₂ for the navigational region is set to be 0.6.

Block 530 separately computes a degree of confidence h of each category for the suggested queries based on the category weight g for each category under each clickable region, and the click attribute weight w for each clickable region.

In this embodiment, Equation (5) is used for computing the degree of confidence of any category for the suggested query:

$$h ( x , y ) = \frac{1}{\vert z \vert} {\sum }_{i = 1}^{k} {ω}_{i} {g}_{i} ( x , y ) {f}_{i} ( x , y ) \qquad ( 5 )$$

h(x,y) is used as a degree of confidence of y for x;

x represents the suggested query;

y represents a characteristic function for a category, e.g., click₁(offer, query) or click₂(query). For a certain category, if the suggested query is present, the value of y is one. If the suggested query is not present, the value of y is zero. As the present embodiment computes h(x,y) for categories that exist, y may be rendered as any category of an object to be computed.

ωᵢ represents a click attribute weight of a clickable region i;

k represents the number of clickable regions;

gᵢ represents a category weight of category y within a clickable region i for the suggested query;

fᵢ (x,y) represents a click attribute corresponding to the clickable region i. With reference to Equation (1) and Equation (2), fᵢ(x,y) takes a value of one if the suggested query is present under category y. Equation (5) is calculated specifically for a correspondence relationship between the suggested query and y. Therefore, the value of fᵢ (x,y) is one. Apparently, the computation of fᵢ (x,y) can be integrated into the computation of gᵢ(x,y);

Z represents a normalization factor, Σ_{y}Σᵢ₌₁^{k}ωᵢgᵢ(x,y)fᵢ(x,y).

In this embodiment, if k=2, the possible values for i are 1 and 2. For instance, in the example of Block 520, Z may be computed as:

Z=(0.8×0.75+0.6×0.8)+(0.8×0.25+0.6×0.2)=1.4;then

h(“apple”,“fruits”)/Z=(0.8×0.75+0.6×0.8)/1.4=77.14%;

h(“apple”,“electronics”)/Z=(0.8×0.25+0.6×0.2)/1.4=22.86%.

Block 540 separately determines target categories for the suggested queries based on the degrees of confidence h of each category for the suggested queries, and displays the suggested query and respective target categories. In this embodiment, implementations of Block 540 may include, but are not limited to, the following:

1. Categories having a degree of confidence greater than a set threshold are rendered as target categories for the suggested queries, and the suggested queries are displayed in a descending order of the degrees of confidence of the target categories. For example, the two target categories corresponding to the query “apple” are the category “fruit” of which the degree of confidence is 77.14%, and the category “electronics” of which the degree of confidence is 22.86%. Both categories have the degree of confidence greater than a set threshold of 20%. Therefore, when displaying suggested term “apple”, the category “fruits” will be displayed first, followed by the category “electronics”. For example,

| | |
|---|---|
| Initial query: app | |
| Suggested query: apple | fruits |
| Suggested query: apple | electronics |

2. Categories having a degree of confidence greater than a set threshold are rendered as target categories for the suggested queries, and the suggested queries are displayed in groups based on types of the target categories. For example, for the initial query “apple”, its suggested queries “apple mobile phone”, “apple MP3” and “apple headphones” correspond to the category “mobile phones” (with degree of confidence as 56%), and the category “digital media players” (with degree of confidence as 44%) respectively, whose degrees of confidence are greater than the set threshold of 20%. Therefore, when displaying the above suggested queries, they will be displayed in groups according to different target categories. For example,

| | | |
|---|---|---|
| Initial query: Apple | | |
| | “mobile phones” | “digital media players” |
| Suggested query: | apple mobile phone | apple MP3 |
| | | apple headphones |

In practical applications, many flexible display methods may be emerged along with the expansion of business. The above two methods are examples for illustration only.

Further, when employing a suggested query selected by the user for further search, the system may perform a search under corresponding target category as opposed to searching under all the possible target categories, thus effectively reducing the amount of information to be searched and further improving the search efficiency.

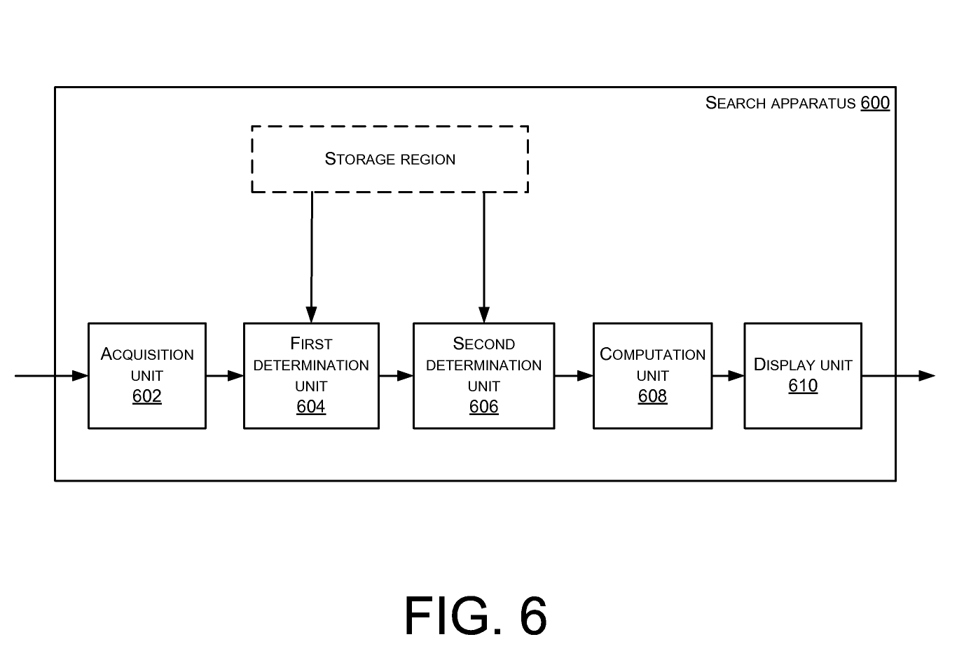

FIG. 6 shows a search apparatus 600 according to another aspect of this disclosure. The search apparatus 600 includes an acquisition unit 602, a first determination unit 604, a computation unit 606, a second determination unit 608, and a display unit 610.

The acquisition unit 602 is used for receiving an initial query input by a user. A suggested query corresponding to the input query is then obtained.

The first determination unit 604 determines at least two categories corresponding to the suggested query and at least two clickable regions usable for looking up the suggested query.

The second determination unit 606 separately determines a category weight associated with each obtained category in each clickable region for the suggested query and a click attribute weight associated with each clickable region.

The computation unit 608 separately computes a degree of confidence of each category for the suggested query based on the category weight associated with each obtained category and the click attribute weight associated with each clickable region.

The display unit 610 separately determines target categories for the suggested query based on the degree of confidence of each category for the suggested query and displays the suggested query and the target categories.

In short, the embodiments of the present disclosure establish a dictionary of suggestions based on a user query log, and develop category suggestions based on a user's click log. Therefore, in response to obtaining corresponding suggested queries based on an initial query (a query keyword) input from a user, a system may determine a target category for each suggested query based on the user's existing click behavior, and display the suggested queries and corresponding target categories at the same time. Accordingly, a guiding intention of each suggested query is displayed to the user based on the target categories, allowing the user to quickly determine his/her search intention based on the target categories of the suggested queries. This avoids interference from unrelated suggested queries, and thereby effectively improves the speed of information searching. Furthermore, the system takes advantage of performing a search under a target category corresponding to a suggested query that is selected by the user as opposed to performing searches under all categories. Amount of information to be searched is therefore greatly reduced, thus further improving the speed of information searching, and reducing the processing workload of an associated server. The present disclosure may be applied in electronic products such as computers, wireless communication devices, etc.

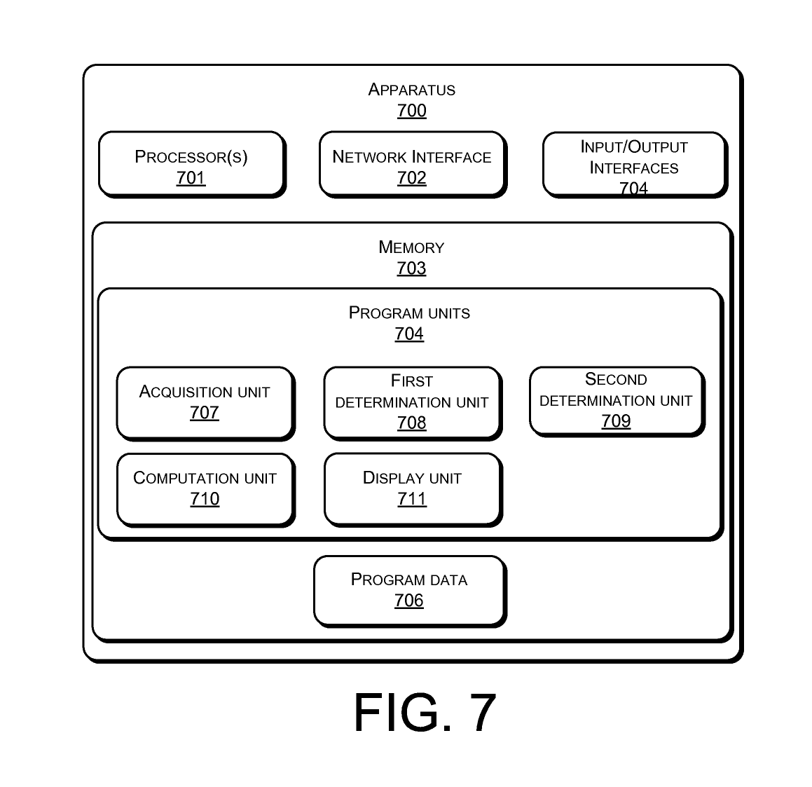

FIG. 7 illustrates an exemplary apparatus 700, such as the apparatus as described above, in more detail. In one embodiment, the apparatus 700 can include, but is not limited to, one or more processors 701, a network interface 702, memory 703, and an input/output interface 704.

The memory 703 may include computer-readable media in the form of volatile memory, such as random-access memory (RAM) and/or non-volatile memory, such as read only memory (ROM) or flash RAM. The memory 703 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 703 may include program units 705 and program data 706. In one embodiment, the program units 705 may include an acquisition unit 707, a first determination unit 708, a second determination unit 709, a computation unit 710 and a display unit 711. Details about these program units and any sub-units and/or modules thereof may be found in the foregoing embodiments described above.

It is noted that one skilled in the art can alter or modify the disclosed method, system and apparatus in many different ways without departing from the spirit and the scope of this disclosure. Accordingly, it is intended that the present disclosure covers all modifications and variations which fall within the scope of the claims of the present disclosure and their equivalents.

What is claimed is:

1. A method of providing suggested terms, the method comprising:
receiving an initial query input from a user;
obtaining a suggested query based on the initial query;
determining at least two categories corresponding to the suggested query and at least two clickable regions usable for looking up the suggested query;
determining a category weight associated with each category in each clickable region for the suggested query;
determining a click attribute weight associated with each clickable region;
computing a degree of confidence of each category for the suggested query based on the category weight associated with each category and a click attribute weight associated with each clickable region;
determining target categories for the suggested query based on the degree of confidence of each category for the suggested query; and
providing the suggested query and the target categories for presentation.

2. The method as recited in claim 1, wherein determining the category weight associated with each category comprises:
determining the category weight based on a function of a number of clicks associated with the respective category in a clickable region for the suggested query and a number of clicks on all categories in the clickable region for the suggested query.

3. The method as recited in claim 1, wherein determining the click attribute weight associated with each clickable region comprises at least one of:
setting the click attribute weight using a maximum likelihood estimation method; or
setting the click attribute weight using a degree of confidence for the clickable region.

4. The method as recited in claim 1, wherein computing the degree of confidence of each category comprises:
computing the degree of confidence using an equation
$$h ( x , y ) = \frac{1}{\vert z \vert} {\sum }_{i = 1}^{k} {ω}_{i} {g}_{i} ( x , y ) {f}_{i} ( x , y ) ,$$
wherein:
h(x,y) is used as a degree of confidence of y for x;
x represents the suggested query;
y represents the respective category;
ωᵢ represents a click attribute weight of a clickable region i;
k represents number of clickable regions;
gᵢ represents a category weight of category y within a clickable region i for the suggested query;
fᵢ (x,y) represents a click attribute corresponding to the clickable region i; and
Z represents a normalization factor, Σ_{y}Σᵢ₌₁^{k}ωᵢgᵢ(x,y)fᵢ(x,y).

5. The method as recited in claim 1, wherein determining the target categories and providing the suggested query and the target categories comprises:
rendering categories having degrees of confidence greater than a set threshold to be the target categories for the suggested query, and providing the suggested query in one of a descending order of degrees of confidence of the target categories or groups based on types of the target categories.

6. The method as recited in claim 1, further comprising:
receiving a selection of a target category of the target categories for the suggested query; and
performing a new search based on the suggested query and the selected category.

7. The method as recited in claim 1, wherein performing the new search comprises performing the new search within the selected category of the suggested query.

8. An apparatus of providing suggested terms, the apparatus comprising:
an acquisition unit to receive an initial query input from a user and obtain a suggested query corresponding thereto based on the initial query;
a first determination unit to determine at least two categories corresponding to the suggested query and at least two clickable regions usable for looking up the suggested query;
a second determination unit to determine a category weight associated with each obtained category in each clickable region for the suggested query, and a click attribute weight associated with each clickable region;
a computation unit to compute a degree of confidence of each category for the suggested query based on the category weight associated with each obtained category and a click attribute weight associated with each clickable region;
a display unit to determine target categories for the suggested query based on the degree of confidence of each category for the suggested query and display the suggested query and the target categories.

9. The apparatus as recited in claim 8, wherein the first determination unit determines the category weight based on a ratio between a total number of clicks on a category in a clickable region for the suggested query to a total number of clicks on all categories in the clickable region for the suggested query.

10. The apparatus as recited in claim 8, wherein the first determination unit sets the click attribute weight using one of a maximum likelihood estimation method or a degree of confidence for the clickable region.

11. The apparatus as recited in claim 8, wherein the second determination unit computes the degree of confidence based on an equation
$$h ( x , y ) = \frac{1}{\vert z \vert} {\sum }_{i = 1}^{k} {ω}_{i} {g}_{i} ( x , y ) {f}_{i} ( x , y ) ,$$
wherein:
h(x,y) is used as a degree of confidence of y for x;
x represents the suggested query;
y represents the respective category;
ωᵢ represents a click attribute weight of a clickable region i;
k represents number of clickable regions;
gᵢ represents a category weight of category y within a clickable region i for the suggested query;
fᵢ (x,y) represents a click attribute corresponding to the clickable region i; and
Z represents a normalization factor, Σ_{y}Σᵢ₌₁^{k}ωᵢgᵢ(x,y)fᵢ(x,y).

12. The apparatus as recited in claim 8, wherein the display unit renders categories having degrees of confidence greater than a set threshold to be the target categories for the suggested query, and provides the suggested query in a descending order of degrees of confidence of the target categories.

13. The apparatus as recited in claim 8, wherein the display unit renders categories having degrees of confidence greater than a set threshold to be the target categories for the suggested query, and providing the suggested query in groups based on types of the target categories.

14. One or more computer-readable media storing computer-readable instructions that, when executed by one or more processors, configure the one or more processors to perform acts comprising:
receiving an initial query input from a user;
obtaining a suggested query based on the initial query;
determining at least two categories corresponding to the suggested query and at least two clickable regions usable for looking up the suggested query;
determining a category weight associated with each category in each clickable region for the suggested query;
determining a click attribute weight associated with each clickable region;
computing a degree of confidence of each category for the suggested query based on the category weight associated with each category and a click attribute weight associated with each clickable area; and
determining target categories for the suggested query based on the degree of confidence of each category for the suggested query; and
providing the suggested query and the target categories for presentation.

15. The one or more computer-readable media as recited in claim 14, wherein determining the category weight associated with each category comprises:
determining the category weight based on a function of a number of clicks associated with the respective category in a clickable region for the suggested query and a number of clicks on all categories in the clickable region for the suggested query.

16. The one or more computer-readable media as recited in claim 14, wherein determining the click attribute weight associated with each clickable region comprises at least one of:
setting the click attribute weight using a maximum likelihood estimation method; or
setting the click attribute weight using a degree of confidence for the clickable region.

17. The one or more computer-readable media as recited in claim 14, wherein computing the degree of confidence of each category comprises:
computing the degree of confidence using an equation
$$h ( x , y ) = \frac{1}{\vert z \vert} {\sum }_{i = 1}^{k} {ω}_{i} {g}_{i} ( x , y ) {f}_{i} ( x , y ) ,$$
wherein:
h(x,y) is used as a degree of confidence of y for x;
x represents the suggested query;
y represents the respective category;
ωᵢ represents a click attribute weight of a clickable region i;
k represents number of clickable regions;
gᵢ represents a category weight of category y within a clickable region i for the suggested query;
fᵢ(x,y) represents a click attribute corresponding to the clickable region i; and
Z represents a normalization factor, Σ_{y}Σᵢ₌₁^{k}ωᵢgᵢ(x,y)fᵢ(x,y).

18. The one or more computer-readable media as recited in claim 14, wherein determining the target categories and providing the suggested query and the target categories comprises:
rendering categories having degrees of confidence greater than a set threshold to be the target categories for the suggested query, and displaying the suggested query in one of a descending order of degrees of confidence of the target categories or groups based on types of the target categories.

19. The one or more computer-readable media as recited in claim 14, the acts further comprising:
receiving a selection of a target category of the target categories for the suggested query; and
performing a new search based on the suggested query and the selected category.

20. The one or more computer-readable media as recited in claim 14, wherein performing the new search comprises performing the new search within the selected category of the suggested query.
